(19) United States
(12) Patent Application Publication
(10) Pub. No.: US 2006/0049059 A1
(43) Pub. Date: Mar. 9, 2006

(54) Method of manufacturing aluminum oxide film with arrayed nanometric pores

(76) Inventors: Chuen-Guang Chao, Hsinchu City (TW); Chien-Chon Chen, Minsyong Township (TW); Jung-Hsuan Chen, Jhubei City (TW); Chin-Guo Kuo, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/006,586

(22) Filed: Dec. 8, 2004

(30) Foreign Application Priority Data
Sep. 7, 2004 (TW) 93126977

(51) Int. Cl. C25D 11/00; B23H 9/00

(52) U.S. Cl. 205/323; 205/640

(57) ABSTRACT

The present invention pertains to a method of manufacturing an aluminum oxide film with arrayed nanometric pores, wherein a commercial aluminum substrate is provided firstly; then the aluminum substrate is annealed and then electro-polished in order to have a mirror-like surface, and then anodized in order to form a aluminum oxide film with a plurality of nanometric pores, which are aligned in array, and then annealed in order that an oxidation reaction can happen thereon and generates oxide, which via self-diffusion, fills some of smaller pores with the pores size being uniformed; lastly a pore-widening is undertaken in order to increase the diameters of the pores. The present invention can accomplish the nanometric pores aligned in array and with an uniform pore diameter, and simultaneously have the advantages of simplified manufacturing process, easier operational control and reduced cost.

### BACKGROUND OF THE INVENTION

(a) Field of the Invention

The present invention relates to a method of manufacturing an aluminum oxide film, particularly to a method of manufacturing an aluminum oxide film with arrayed nanometric pores.

(b) Description of Related Art

In present, aluminum alloys have been widely used, mainly because it includes the following characteristics: only one-third of specific gravity of iron, outstanding corrosion resistance, superior thermal-conductivity, diversification of mechanical properties that a variety of products of aluminum alloys with different grades of strength can be manufactured via addition of alloy elements, rolling or heat treatment and superior surface treatment capability including anodizing, surface chemical conversion, coating, electroplating, etc. Especially, an anodizing can generate a variety of skin layers with different tints and hardness. Anodizing is an electrochemical treatment to form a dense oxide film on the surface of aluminum alloys in order to promote the corrosion resistance of aluminum alloys.

For the time being, Anodic Aluminum Oxide (AAO) has been widely utilized in large-scale industries and various research organizations, such as semiconductor industry, optoelectronic industry, biomedical industry, universities and research organizations. AAO can be directly applied to nanometric processes, and the template with a nanometric-pored aluminum oxide is also widely applied to various products.

A method had been proposed by a scholar that a high purity aluminum (99.999%) is adopted as the substrate of AAO, and one step anodic process is undertaken with the electrolyte being a solution containing 10% of sulfuric acid or oxalic acid, at an anodizing temperature below 10° C. and for an anodizing duration varying from 24 to 100 hours, and then followed by a 30 minutes of pore-widening treatment in order to array the nanometric pores on AAO into a regular alignment. As the 99.999% high purity aluminum is adopted in this method, the cost of material is raised, and as the anodizing temperature needs to be controlled below 10° C., additional temperature-controlling equipment is necessary, and thus the cost of equipment is also raised. Further, the duration of the anodizing procedure used in this method is pretty long.

An another scholar utilizes a method, wherein a die with arrayed asperities, which is formed on a single crystal silicon carbide (SiC) substrate via an electron beam lithography, is adopted; the die is disposed on an electro-polished substrate of a 99.99% high purity aluminum, and then a pressure of 5 tons·cm⁻² is applied upon the die to reprint the pattern of the arrayed asperities onto the substrate; then the substrate is processed through a single-stage anodizing treatment and a pore-widening treatment. Although the process of anodizing treatment is reduced from two stages to one stage and the purity of the aluminum substrate is reduced from 99.999% to 99.99%, the efficiency of utilizing the electron beam lithography to carve arrayed asperities on the single crystal silicon carbide (SiC) substrate is pretty low, and the cost thereof is very high. Further, the service cycles of the die, which is under the high pressure of 5 tons·cm⁻², are very limited.

Moreover, yet another scholar utilizes a method, wherein a high purity aluminum (99.999%) is adopted as the substrate, and one step anodic process is undertaken at a low temperature with the electrolyte being a solution of sulfuric acid or oxalic acid; then a solution contain 6% of H₃PO₄+1.8% of H₂CrO₂+H₂O is utilized to dissolve the aluminum oxide formed in the first anodizing treatment, and thus a pattern of nanometric array is retained on the surface of the aluminum substrate; then the aluminum substrate is processed through a second anodizing treatment and a pore-widening treatment in order to form arrayed nanometric pores on the aluminum oxide film. However, as a small portion of aluminum substrate is also dissolved while utilizing the solution containing 6% of H₃PO₄+1.8% of H₂CrO₂+H₂O to dissolve the aluminum oxide, the dissolving duration needs a precise control. If the dissolving duration is too short, some of the aluminum oxide film will be retained on the aluminum substrate. If the dissolving duration is too long, the pattern of nanometric array will disappear. Further, as the anodizing treatment is utilized twice, the manufacturing process becomes very complicated.

Owing to those described above, the present invention provides a method of manufacturing an aluminum oxide film with arrayed nanometric pores in order to improve the aforementioned drawbacks.

### SUMMARY OF THE PRESENT INVENTION

The primary objective of the present invention is to provide a method of manufacturing an aluminum oxide film with arrayed nanometric pores, which utilizes one step anodic process and processes of a heat treatment and a pore-widening treatment in order to achieve an arrayed alignment of uniform-diameter nanometric pores on the aluminum oxide film.

Another objective of the present invention is to provide a method of manufacturing an aluminum oxide film with arrayed nanometric pores, which utilizes a heat treatment to take the place of the conventional second anodizing treatment in order to make the operational control of manufacturing process easy.

A further objective of the present invention is to provide a method of manufacturing an aluminum oxide film with arrayed nanometric pores, which adopts a commercial-grade aluminum substrate of ordinary purity, whose price is far lower than a high purity aluminum, in order to reduce the cost.

A further another objective of the present invention is to provide a method of manufacturing an aluminum oxide film with arrayed nanometric pores, wherein the price of the heat treatment equipment adopted in the present invention is far lower than the conventional focused ion beam, and the cost of the equipments utilized in the manufacturing method of the present invention is thus reduced.

In order to achieve the aforementioned objectives, the present invention provides a method of manufacturing an aluminum oxide film with arrayed nanometric pores, wherein an aluminum substrate is provided firstly; the aluminum substrate is annealed, and then the surface of the aluminum substrate is electro-polished, and then anodized in order to form an aluminum oxide film with a plurality of nanometric pores, and the pores are aligned in array; further, a heat treatment is performed in order that an oxidation reaction can happen on the surface of the aluminum substrate, and then, via a self-diffusion of the oxide, the smaller pores will disappear, and the larger pores will shrink, and thus the sizes of the pores are uniformed; lastly, a pore-widening treatment is undertaken in order to increase the diameter of the pores.

### BRIEF DESCRIPTION OF THE DRAWINGS

FIG. 1 is a flowchart of manufacturing process according to one aspect of the present invention.

FIG. 2 is a photograph of the pore distribution of a product of the conventional method.

FIG. 3 is a photograph of the pore distribution of a product of the method according to one embodiment of the present the invention.

### LIST OF REFERENCE NUMERALS

| | |
|---|---|
| S10 | providing an aluminum substrate |
| S12 | annealing |
| S14 | electro-polishing |
| S16 | anodizing |
| S18 | heat treatment |

### PREFERRED EMBODIMENTS OF THE PRESENT INVENTION

Via the attached drawings and the embodiments of the present invention described below, the objectives, technical contents, characteristics and accomplishments of the present invention are to be more easily understood.

In re the drawbacks of the high cost and complicated process of the conventional method of manufacturing the Anodic Aluminum Oxide (AAO), the present invention provide a method of manufacturing an aluminum oxide film with arrayed nanometric pores.

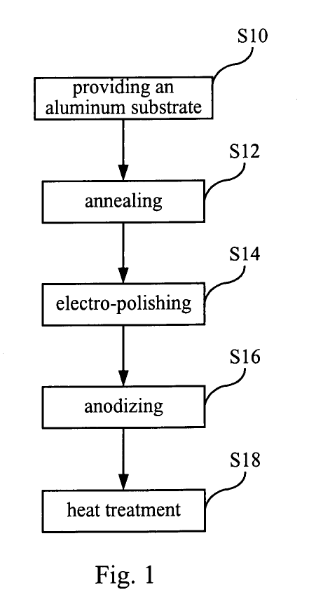

Referring to FIG. 1 a flowchart of manufacturing process according to one aspect of the present invention, the manufacturing process of the present invention includes the following steps:

S10—providing an aluminum substrate, wherein the aluminum substrate can be selected from commercial aluminum substrates of an ordinary purity of less than 99.9%, such as 103, 107,1050, 1070 etc. in 100 or 1000 series of aluminum in ASTM, and then the process proceeds to the step S12;

S12—annealing the aluminum substrate, wherein the aluminum substrate is annealed at a temperature ranging from 200 to 650° C. for a duration of more than one hour, and then the process proceeds to the step S14;

S14—electro-polishing the aluminum substrate surface, wherein the aluminum substrate surface is electro-polished for a duration varying from 4 to 10 minutes, in a electrolyte solution containing 15% to 30% of hyperchloric acid (HClO₄), 15% to 30% of (CH₃(CH₂)₃OCH₂CH₂OH) and 40% to 70% of ethanol (C₂H₅OH) at a temperature ranging from 15 to 30° C., and with a 32 to 42V direct current, and thus the aluminum substrate surface thereafter has a smoother, mirror-like surface, which advantages the formation of an aluminum oxide film, and then the process proceeds to the step S16;

S16—anodizing the aluminum substrate, wherein the aluminum substrate is anodized in order to form an aluminum oxide film with a plurality of nanometric (such as 10 to 100 nm) pores, which are aligned in array, and the thickness of the aluminum oxide film will be from 10 to 130 μm, and wherein the anodizing treatment is undertaken in an electrolyte solution containing 0.3 to 0.4 molar concentration of oxalic acid(C₂H₂O₄) at a temperature ranging from 15 to 30° C., for a duration of 1 to 8 hours and with a 35 to 42 V direct current, or in an electrolyte solution containing 9 to 15% of boric acid(H₃BO₃) at a temperature ranging from 90 to 95° C., for a duration of 1 to 10 hours and with a 50 to 80 V direct current, or in an electrolyte solution containing 4 to 8% of phosphoric acid(H₃PO₄) at a temperature ranging from 0 to 10° C., for a duration of 0.5 to 24 hours and with a 50˜70 V direct current, or in an electrolyte solution containing 2 to 8% of chromic acid(CrO₃) at a temperature ranging from 35 to 45° C., for a duration of 0.5 to 24 hours and with a 30 to 50 V direct current, and the electrolyte solution of the anodizing treatment can also be a mixture of the solutions selected from the solutions of hyperchloric acid, sulfuric acid, boric acid, oxalic acid, phosphate, oxalate, citrate, carbonate, tartrate, mangnate, silicate and chromate; and wherein the step S16 is followed by the step S18;

S18—undertaking a heat treatment, wherein the heat treatment is to solve the problems of the nonunformity of the pore size and the defective secondary pores formed inside the aluminum oxide after the anodizing treatment, and wherein the heat treatment is undertaken at a temperature ranging from 400 to 600° C., under the atmospheric pressure and for a duration of 2 to 10 hours, or under a oxygen partial pressure less than 0.2 atmospheric pressure and for a duration of 2 to 6 hours, or under a vacuum state(10⁻¹˜10⁻⁹ torr) and for a duration of 2 to 30 hours, in order that an oxidation reaction can happen on the aluminum substrate and generates the aluminum oxide(Al₂O₃), which via self-diffusion, fills some of smaller pores and shrinks the diameter of larger pores, and thus the pores on the surface of AAO are uniformed and represent 15 to 50 nm of pore diameter, and lastly the process proceeds to the step S20;

S20—pore-widening, wherein the pore-widening treatment is undertaken in a pore-widening solution containing 3 to 8% of phosphoric acid at a temperature ranging from 22 to 35° C., in order to increase the pore diameter to from 60 to 85 nm with a pore density of 10⁹ to 10¹¹ pores/cm², and the pore-widening solution can also be a mixture of solutions selected from the solutions of 5 to 20% of sulfuric acid, 3 to 10% of phosphoric acid, 3 to 10% chromic acid and 3 to 6% of oxalic acid;

wherein after the step S14—electro-polishing, the surface of the aluminum substrate can be rinsed in ethanol, and then the aluminum substrate is dried with warm air, and wherein after the step S20—pore-widening and after the formation of the aluminum oxide film with uniformed and arrayed pores, if a product need only the aluminum oxide film and does not need the aluminum substrate, the aluminum substrate can be removed therefrom.

The temperature of the solutions for the aforementioned electro-polishing treatment, anodizing treatment or pore-widening treatment all must be controlled at a given range. If the temperature is too high, the processing will be too fast; if the temperature is too low, the processing will be too slow. Either too fast or too slow, the pore diameters are apt to be uneven, which will result in that the arrayed uniform pores wouldn't appear.

To clarify the advantage of the present invention further, the product manufactured via the method according to one embodiment of the present invention and the product manufactured via a conventional method are observed via an experiment. In this experiment, the conventional method is that a high purity aluminum substrate (99.999%) is adopted, and the surface of a test sample is rinsed with acetone, and then the test sample is processed sequentially with an annealing treatment, an electro-polishing treatment, a first anodizing treatment, removing AAO, a second anodizing treatment and a pore-widening treatment. In this experiment, the method according to one embodiment of the present invention is that, in contrast to the high purity aluminum substrate, a commercial grade aluminum substrate is adopted, and then the test sample is processed sequentially with an annealing treatment, an electro-polishing treatment, a first anodizing treatment, a heat treatment and a pore-widening treatment. The parameters of both the methods in this experiment are shown in Table 1.

TABLE 1

| | | De- | | Electro- | First | Removing | Second | Heat | Por [symbol] |
|---|---|---|---|---|---|---|---|---|---|
| | Al (%) | greasing | Annealing | polishing | anodizing | AAO | anodizing | treatment | wid [symbol] |
| The prior | 99.999 | acetone | 500° C. | H₃PO₄: | 0.3 M | 6% H₃PO₄ + | 0.3 M | — | 5% [symbol] |
| art | | | 4 hrs | H₂SO₄: | (C₂H₂O₄) | 1.8% | (C₂H₂O₄) | | 30° [symbol] |
| | | | vacuum | H₂O═ | 40 V | H₂CrO₂ + | 40 V | | 30 [symbol] |
| | | | state | 4:2:2 | 5° C. | H₂O | 5° C. | | |
| | | | 10⁻³ | | 10 hrs | 60° C., 12 | 10 hrs | | |
| | | | atmospheric | | | hrs | | | |
| | | | pressure | | | | | | |
| The | 99.7 | — | 500° C. | 15% HClO₄ + | 0.3 M | — | — | 350˜ | 6% [symbol] |
| Present | | | 1 hr | 15% | (C₂H₂O₄) | | | 600° C. | 50˜ [symbol] |
| invention | | | 1 | CH₃(CH₂)₃O | 40 V | | | 1˜4 hrs | min [symbol] |
| | | | atmospheric | CH₂CH₂OH + | 22° C. | | | | |
| | | | pressure | 70% C₂H₅OH | 1 hr | | | | |
| | | | | 25° C., 36 V, | | | | | |
| | | | | 6 mins | | | | | |

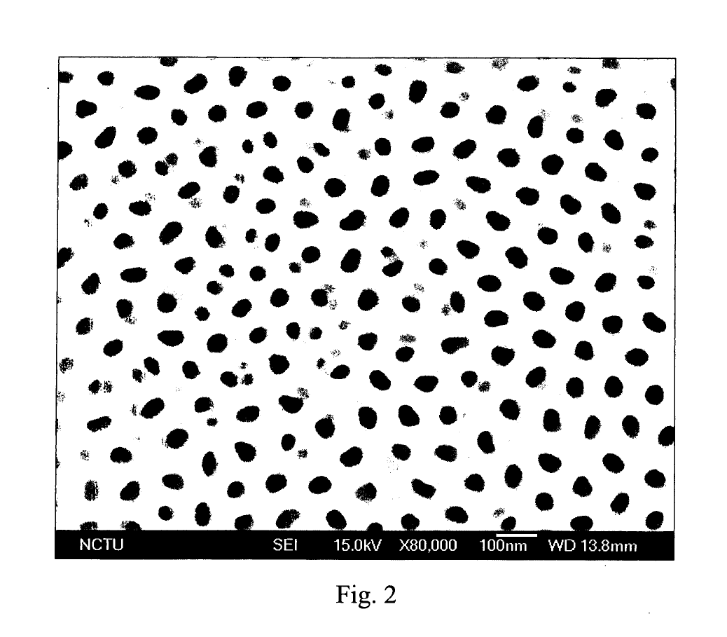

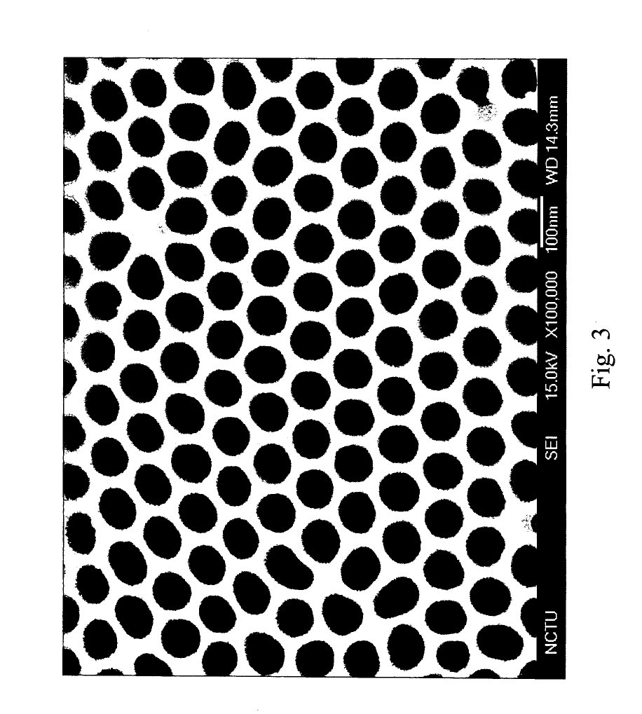

When the commercial grade aluminum substrate of 99.7% purity is adopted in this experiment for both the conventional method and the method according to the embodiment of the present the invention, the experiment results thereof are shown in FIG. 2 and FIG. 3 photographs via a scanning electron microscope (SEM). JEOL JSM-6500F SEM is adopted in this experiment to observe the distribution of the pores. FIG. 2 is a photograph of the pore distribution of a product of the conventional method. FIG. 3 is a photograph of the pore distribution of a product of the method according to the embodiment of the present the invention. From FIG. 2, it can be observed that the pores on the surface of the AAO film, which is manufactured via the conventional method, in contrast to arrayed alignment, are randomly aligned and of different size, and there are many defective and smaller secondary pores inside the oxide film. From FIG. 3, it can be observed that the pores on the surface of the AAO film, which is manufactured via the method of the single-stage anodizing and the heat treatment according to the embodiment of the present invention, are aligned in array and of the same size.

The present invention can apply to a variety of fields such as electrochemistry, nanometric technology, semiconductor, optoelectronics and biomedicine, and the present invention can be used to fabricate a variety of products such as field emission display, high capacity data recorder, high sensitivity gas sensor and DNA template, etc.

The present invention provides a method of manufacturing an aluminum oxide film with arrayed nanometric pores, which utilizes a one-stage anodizing treatment and a heat treatment to take the place of the conventional two-staged anodizing treatment in order to simplify the conventional manufacturing process and make the operational control easy. The present invention also provides an aluminum oxide film with arrayed nanometric pores. Further, the present invention adopts a commercial grade aluminum substrate of ordinary purity to take the place of a high purity aluminum substrate. As the price of a commercial grade aluminum is far lower than a high purity aluminum, the cost of material is thus reduced. Moreover, as the price of the heat treatment equipment is far lower than the focused ion beam equipment used by the conventional method, thus the cost of equipment is also reduced.

Those described above are to enable persons skilled in the art to understand, make and use the present invention more easily; it is not intended to limit the scope of the present invention. Any equivalent modification and variation without departing from the spirit of the present invention is to be included within the scope of the present invention.

What is claimed is:

1. A method of manufacturing an aluminum oxide film with arrayed nanometric pores, comprising:
providing an aluminum substrate;
annealing said aluminum substrate;
electro-polishing the surface of said aluminum substrate;
anodizing said aluminum substrate, in order to form an aluminum oxide film with nanometric pores, which are aligned in array, on the surface of said aluminum substrate;
heat-treating said aluminum substrate, in order that an oxidation reaction can happen on the surface of said aluminum substrate and generates oxide, which via self-diffusion, fills some of smaller said pores and shrink the diameter of larger said pores, with the result that said pores are uniformed; and
pore-widening, in order to increase the diameters of said pores.

2. The method of manufacturing an aluminum oxide film with arrayed nanometric pores according to claim 1, wherein said aluminum substrate is annealed at a temperature ranging from 200 to 650° C. and for a duration of more than 1 hour.

3. The method of manufacturing an aluminum oxide film with arrayed nanometric pores according to claim 1, wherein the surface of said aluminum substrate is electro-polished in a mixed solution containing 15% to 30% of hyperchloric acid (HClO₄), 15% to 30% of (CH₃(CH₂)₃OCH₂CH₂OH) and 40% to 70% of ethanol(C₂H₅OH).

4. The method of manufacturing an aluminum oxide film with arrayed nanometric pores according to claim 3, wherein the temperature of said mixed solution ranges from 15 to 30° C.

5. The method of manufacturing an aluminum oxide film with arrayed nanometric pores according to claim 1, wherein the surface of said aluminum substrate is electro-polished with a 32 to 42 voltage of direct current and for a duration ranging from 4 to 10 minutes.

6. The method of manufacturing an aluminum oxide film with arrayed nanometric pores according to claim 1, wherein after said electro-polishing, said aluminum substrate has a mirror-like surface.

7. The method of manufacturing an aluminum oxide film with arrayed nanometric pores according to claim 1, wherein the thickness of said aluminum oxide film ranges from 10 to 130 micrometers.

8. The method of manufacturing an aluminum oxide film with arrayed nanometric pores according to claim 1, wherein after said anodizing, the diameter of said pores ranges from 10 to 100 nanometers.

9. The method of manufacturing an aluminum oxide film with arrayed nanometric pores according to claim 1, wherein the anodizing solution is selected from one of the combinatorial sets of the solutions of hyperchloric acid, sulfuric acid, boric acid, oxalic acid, phosphate, oxalate, citrate, carbonate, tartrate, mangnate, silicate and chromate.

10. The method of manufacturing an aluminum oxide film with arrayed nanometric pores according to claim 9, wherein said anodizing is operated in a solution containing 0.3 to 0.4 molar concentration of oxalic acid(C₂H₂O₄) at a temperature ranging from 15 to 30° C., for a duration of 1 to 8 hours and with a 35 to 42 V direct current.

11. The method of manufacturing an aluminum oxide film with arrayed nanometric pores according to claim 9, wherein said anodizing is operated in a solution containing 9 to 15% of boric acid(H₃BO₃) at a temperature ranging from 90 to 95° C., for a duration of 1 to 10 hours and with a 50 to 80 V direct current.

12. The method of manufacturing an aluminum oxide film with arrayed nanometric pores according to claim 9, wherein said anodizing is operated in a solution containing 4 to 8% of phosphoric acid(H₃PO₄) at a temperature ranging from 0 to 10° C., for a duration of 0.5 to 24 hours and with a 50˜70 V direct current.

13. The method of manufacturing an aluminum oxide film with arrayed nanometric pores according to claim 9, wherein said anodizing is operated in a solution containing 2 to 8% of chromic acid(CrO₃) at a temperature ranging from 35 to 45° C., for a duration of 0.5 to 24 hours and with a 30 to 50 V direct current.

14. The method of manufacturing an aluminum oxide film with arrayed nanometric pores according to claim 1, wherein said heat-treating is operated at a temperature ranging from 400 to 600° C., under the atmospheric pressure and for a duration of 2 to 10 hours.

15. The method of manufacturing an aluminum oxide film with arrayed nanometric pores according to claim 1, wherein said heat-treating is operated under a vacuum state and for a duration of 2 to 30 hours.

16. The method of manufacturing an aluminum oxide film with arrayed nanometric pores according to claim 1, wherein said heat-treating is operated under an oxygen partial pressure less than 0.2 atmospheric pressure and for a duration of 2 to 6 hours.

17. The method of manufacturing an aluminum oxide film with arrayed nanometric pores according to claim 1, wherein after said heat-treating, the diameter of said pores ranges from 15 to 50 nanometers.

18. The method of manufacturing an aluminum oxide film with arrayed nanometric pores according to claim 1, wherein said pore-widening is operated in a pore-widening solution containing 3 to 8% of phosphoric acid at a temperature ranging from 22 to 35° C.

19. The method of manufacturing an aluminum oxide film with arrayed nanometric pores according to claim 1, wherein the duration of said pore-widening ranges from 65 to 120 minutes.

20. The method of manufacturing an aluminum oxide film with arrayed nanometric pores according to claim 1, wherein after said pore-widening, the diameter of said pores is increased to ranging from 65 to 85 nanometers.

21. The method of manufacturing an aluminum oxide film with arrayed nanometric pores according to claim 20, wherein the pore density ranges from 10⁹ to 10¹¹ pores/cm².

22. The method of manufacturing an aluminum oxide film with arrayed nanometric pores according to claim 1, wherein said pore-widening is operated in a pore-widening solution selected from one of the combinatorial sets of the solutions of 5 to 20% of sulfuric acid, 3 to 10% of phosphoric acid, 3 to 10% chromic acid and 3 to 6% of oxalic acid.

23. The method of manufacturing an aluminum oxide film with arrayed nanometric pores according to claim 1, wherein after said pore-widening, said aluminum substrate is further removed.

24. The method of manufacturing an aluminum oxide film with arrayed nanometric pores according to claim 1, wherein after said electro-polishing, said aluminum substrate is further rinsed and then dried with warm air.

25. The method of manufacturing an aluminum oxide film with arrayed nanometric pores according to claim 24, wherein said aluminum substrate is rinsed in ethanol.
